(19) United States
(12) Patent Application Publication
(10) Pub. No.: US 2011/0143318 A1
(43) Pub. Date: Jun. 16, 2011

(54) Winged implant

(76) Inventors: Zvi Laster, Poriya Elite (IL); Ole T. Jensen, Engelwood, CO (US); Meir Mamraev, Rishon Lezion (IL)

(21) Appl. No.: 12/926,286

(22) Filed: Nov. 8, 2010

Related U.S. Application Data
(60) Provisional application No. 61/398,331, filed on Jun. 24, 2010.
(60) Provisional application No. 61/283,976, filed on Dec. 11, 2009.

(51) Int. Cl. A61C 8/00

(52) U.S. Cl. 433/174

(57) ABSTRACT

A winged implant may be provided with at least one wing extending generally radially away from a implant body adjacent a distal end thereof. During an implant procedure, the winged implant may be implanted in a crater, whereby the at least one wing may offer an enhanced support of the winged implant in the crater.

### CROSS-REFERENCE TO RELATED APPLICATIONS

This application claims priority to U.S. Provisional Patent Application Ser. No. 61/398,331, filed Jun. 24, 2010, titled “Winged Implant”, itself claiming priority to U.S. Provisional Patent Application Ser. No. 61/283,976, filed Dec. 28, 2009, titled “Winged Implant”.

### FIELD OF THE DISCLOSURE

Disclosed is a winged implant, which may used, by way of example only, to be applied to a bone, may further receive a bolt, a screw, or any other applicable attachment thereto.

### BACKGROUND

Generally, implants are adapted to be used during an implant procedure. Generally, during implant procedures, a crater may be formed, which may initially be filled with congealing blood and bone fragments. The crater may generally be of a frusto-conical shape.

As may be customary, implant procedures may take place immediately or relatively soon after the crater is formed. Thus, the implant may be only partially lodged in solid bone, with a considerable portion thereof extending substantially unsupported towards the crater, leaving the implant to operate mostly as a cantilever. Such mode of operation may compromise implant stability, as is well known in the art, and as may be measured as an ISQ (see http://en.wikipedia.org/wiki/Implant_stability_quotient, incorporated herein by reference). Improved implant stability may enhance osseointegration (http://en.wikipedia.org/wiki/Osseointegration, incorporated herein by reference). Such a requirement for stability is greatly desired, particularly if immediate loading is performed subsequent to the implant procedure.

FR2645011 to Serban, Florian, titled “Bone Implant Eyebolt Which Is Intended On The One Hand To Form An Artificial Tooth Root And On The Other Hand To Reduce Bone Fractures, And Which Can Be Used In Ear, Nose And Throat Treatment” discloses, inter alia, (a) “Device for fixing an implant eyebolt to the bone in order to hold in position a tooth prosthesis, a hearing aid, and to reduce bone fractures. It consists of a cylinder 1 made of metal of the “pure titanium for medical use” type, provided in its upper part with a flatheaded screw 4 having a slot 5 so that it can be maneuvered by a screwdriver, and provided in its lower part with two cylindrical pins 2 for locking the implant to bone. Prior to the positioning of this implant eyebolt, a bore is drilled with a bone-drill burr of the dimension of the eyebolt with a stop, a grinding burr with stop for the lateral and circular grinding/burring of the lower part 9, and a bone fissure bur with a stop for burring two small lateral walls. The device makes it possible to hold in position, by means of implant 12, a tooth prosthesis, a hearing aid, and to reduce bone fractures by locking the implant eyebolt to the bone, and the device permits osteointegration in the parts left empty by the burring and grinding.”

U.S. Pat. No. 4,722,687 to Scortecci, Gerard, titled “Dental Implant For The Securement Of Fixed Dental Prostheses” discloses, among other things, “A dental implant that serves as its own cutting tool for forming a T-shaped slot in a human tooth to receive the implant, comprises a flat circular wheel having cutting teeth on its periphery. The wheel has a diameter that is a plurality of times its thickness. An elongated shaft is secured coaxially to the wheel and has milling surfaces thereon that extend from the wheel a distance which is a plurality of times greater than the thickness of the wheel and a plurality of times greater than the diameter of the milling surfaces. The diameter of the wheel is a plurality of times greater than the diameter of the milling surfaces. A portion of the shaft extending beyond the milling surfaces in a direction away from the wheel permits the re-leasable securement of the implant to a dental drill.”

US2006110707 to Perez, Davidi Michael and Levy, Haim, titled “Dental Implant”, discloses, inter alia, “ . . . a rounded, mill-like member having an external diameter d1 centered in said implant's main axis and coaxial with a secondary (horizontal) axis located in a right angle with said implant's main axis, said mill-like member is characterized by a jagged milling surface in the distal end thereof facing the jawbone; an abutment located in the proximal end and exceeding from said mill-like member towards the oral cavity; wherein said drill-like member is adapted to penetrate perpendicularly to a depth of about 1 as to accommodate an intra-bony portion of the jawbone, while the mill-like member is fixated in a diameter d1 to a supra-bony portion of the jawbone.

“Surprisingly, the dental implant according to the present invention is endowed with an improved durability to the forces generated during oral activity such as mastication or the like, and is resistant against perpendicular forces as well as lateral forces, yet the insertion thereof into a patient's jawbone is performed in a single-step operation, and does not require cutting a second incision or more in the patient's mouth, thus combining the advantages of vertical penetrating implants, i.e. short treatment and healing process and lesser risks of infection, with the strength and long-withstanding of laterally inserted implants, achieved due to the efficient fastening mechanism provided, securing in place the implant to the bone.”

DE4142584 to Lang, Manfred, titled “Dental Implant For Retaining False Tooth—Has Sickle Shaped Ribs With Sharp Edges Arranged In Helix”, discloses “The dental implant, for retaining a false tooth, has a cylindrical upper part (2) and a tapered lower part (1). The lower part has a number of sickle shaped ribs (3) which project radially outwards. The ribs are positioned so that they lie on a helix which winds around the tapered lower part. When the implant is inserted in the alveole in the patient's jaw these ribs cut into the walls of the alveole and hold the implant in place. The upper part of the implant has a tapped hole to receive the screwed shank of the false tooth. USE/ADVANTAGE—The implant for retaining a false tooth need not be inserted to the full depth of the alveole.”

It would be desirable to have a wing implant that, when attempting un-screwing, will tend to resist it. Further, it would be desirable to enhance an implant stability, as may be measured as an ISQ (see http://en.wikipedia.org/wiki/Implant_stability_quotient, incorporated herein by reference). Therefore, there currently exists a need in the industry for an implant and associated method that may tend to resist application of unscrewing torque applied thereto, and which may tend to resist bending moments and forces applied. This may be attained with the subject matter in accordance with the claims.

### SUMMARY

In the following disclosure, aspects thereof are described and illustrated in conjunction with systems and methods which are meant to be exemplary and illustrative, not limiting in scope.

The present disclosure is broadly related to an implant designed for implantation, and more specifically in human and/or animal tissue, and to a method associated with the aforementioned implant. With respect to the implant, it may comprise an implant body, which may be generally shaped as a self-tapping screw, and may be capable of tapping into bone tissues during an implant procedure, and also capable of resisting, or tendering to resist, side-ways forces, after the implant has set (i.e., after osseointegration). A core component of the implant may be an at least one wing extending generally transversely to, and away from, a longitudinal axis of the implant body.

With respect to an associated method, steps may be carried out, which involve providing an at least one wing extending generally transversely to, and away from, a longitudinal axis of the implant body, so that when applying side-ways forces to the implant, the at least one wing may contact a sidewall of a cavity formed before and/or during implant procedure, and contribute to stabilizing the implant implanted in the cavity.

According to an aspect of the present disclosure, an implant may be provided having an implant body comprising an apical end, a distal end and a longitudinal axis L extending through the apical end and the distal end, and at least one wing extending generally transversely to the longitudinal axis L and away from the implant body.

Possibly, the at least one wing may extend generally transversely to the longitudinal axis L from a wing root where the at least one wing joins the implant body to a cantilevered wing end, and comprising a chord arch extending from a tangentially forwardly disposed leading end to a tangentially rearwardly disposed trailing end, the chord arch having a peripheral extent that is considerably smaller than an extent of a circumference of the distal end of the implant body. The at least one wing may be disposed on the anchor body adjacent the distal end thereof.

Further possibly, the at least one wing may have any desirable wing section, including, but not limited to, a rhomb wing section, a round wing section, a teardrop wing section, a trigon wing section, an ellipsoid wing section, a triangular wing section, and a square wing section.

Alternatively, the at least one wing may further comprise a wing sup-port which may extend from an apical face of the at least one wing to terminate at the distal end of the implant body.

Potentially, the wing implant body may have an impression at its distal end.

Moreover, the wing implant body may be formed with a threaded receptacle to receive a threaded screw or bolt.

Potentially, a longitudinal cross-wing section through a distal end of the winged implant may comprise a wing chord section of a trapezoid in shape having a wide wing root and tapering away towards a wing tip.

Optionally, the at least one wing may generally follows a spiral path along a periphery of the distal end of the wing implant, as well as may potentially form a portion of a helical thread.

Further potentially, the at least one wing may comprise a further narrowing of the wing tip, to facilitate threading-in of the winged implant.

Possibly, a chord arch, or a peripheral extent of the at least one wing, may extent peripherally along a circumference of the distal end of the implant body such that the extent of the chord arch may be considerably smaller than the extent of the circumference.

Optionally, the wing implant may comprise a plurality of instances of the at least one wing. Each of the at least one wing instances may be located at a different height, and/or staggered either circumferentially and/or longitudinally about the distal end of the anchor body.

Possibly, all instances of the at least one wing may be disposed about a single helix (not shown).

According to another aspect of the present disclosure, during an implant procedure, an exemplary method of enhancing stability of the implant may be employed. According to such an exemplary method, the implant body may be provided with at least one wing, extending generally away from the wing implant body adjacent a distal end thereof. When the winged implant is implanted, for example in a crater which may be formed during implant procedure, the implant body may be further supported by the at least one wing, thereby enhanced stability of the winged implant in the crater may be effected.

In addition to the exemplary aspects and embodiments described above, further aspects and embodiments will become apparent by reference to the figures and by study of the following detailed descriptions.

### BRIEF DESCRIPTION OF DRAWINGS

Exemplary embodiments are illustrated in referenced figures and drawings. It is intended that the embodiments and figures disclosed herein are to be considered illustrative rather than restrictive.

Reference will now be made to the accompanying drawings, in which:

FIG. 1a is a schematic wing sectional partial view of a winged implant implanted in a tissue;

FIG. 1b is a schematic wing sectional view of the winged implant, implanted in a tissue, shown on FIG. 1a;

FIGS. 2 to 9 depict various exemplary cross wing sections of at least one wing of the winged implant;

FIG. 10 shows a possible modification to a wing of the winged implant shown schematically in FIGS. 1a and 1b; and

FIGS. 11 to 15 schematically show several other exemplary embodiments of the winged implant.

### DETAILED DESCRIPTION

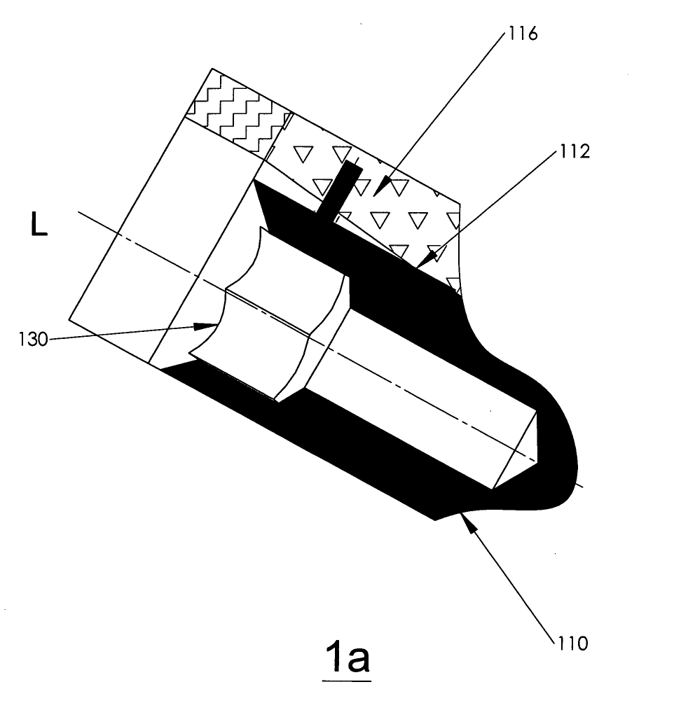

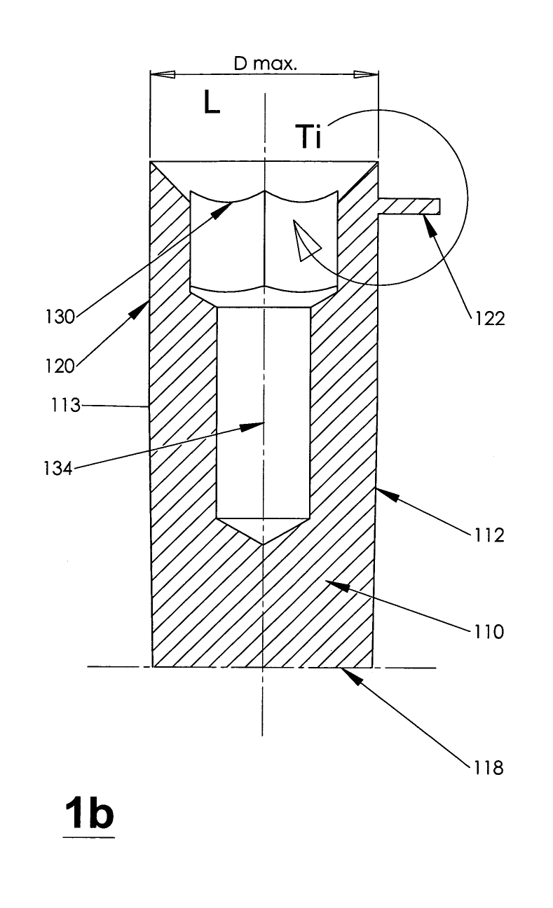

Attention is drawn to FIG. 1a. A wing implant 110 may be designed to be implanted into and/or onto a substrate 116. For illustrative purposes only, such substrates 116 may include, but are not limited to, bone or osseous tissues (see http://en.wikipedia.org/wiki/Bone_tissue, http://en.wikipedia.org/wiki/Osseous_tissue, incorporated herein by reference).

Attention is now additionally drawn to FIG. 1b. The implant body 112 may have a generally cylindrical and/or frusto-conical implant body 112 comprising a body core 113 having a core maximal diameter D_{Max}. The implant body comprises an apical end 118 and a distal end 120, which may releasably secure a screw or a bolt (not shown) to a substrate 116. A longitudinal axis L extends through the apical end 118 and the distal end 120. A screwing-in direction Ti may be defined about the longitudinal axis L. The distal end 120 of the wing implant body 112 may have a distinct, at least one wing 122 extending generally radially from the distal end 120.

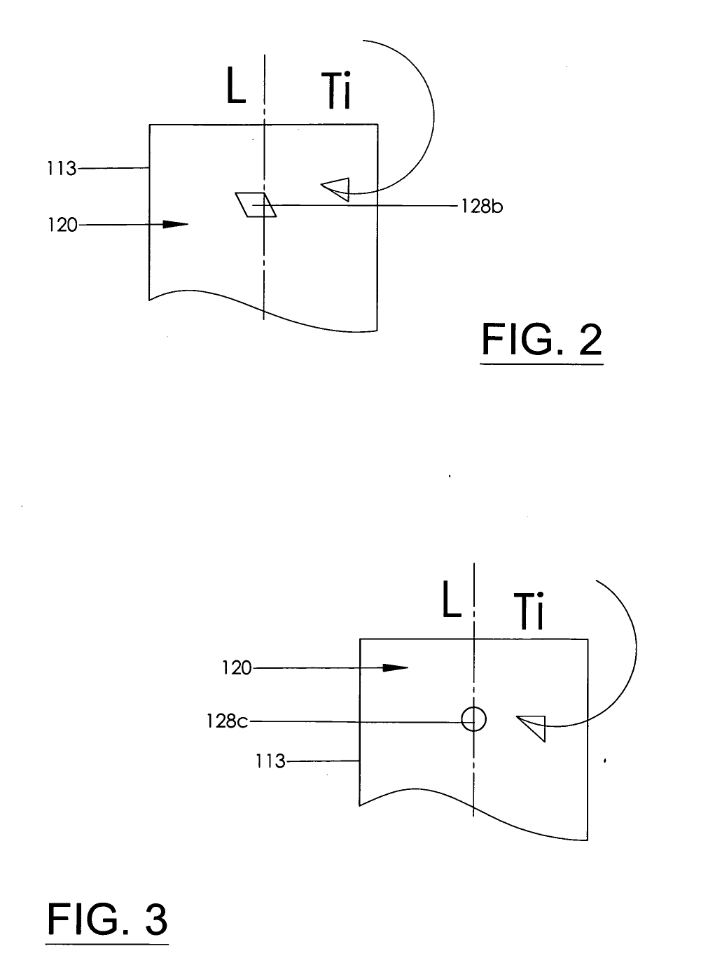

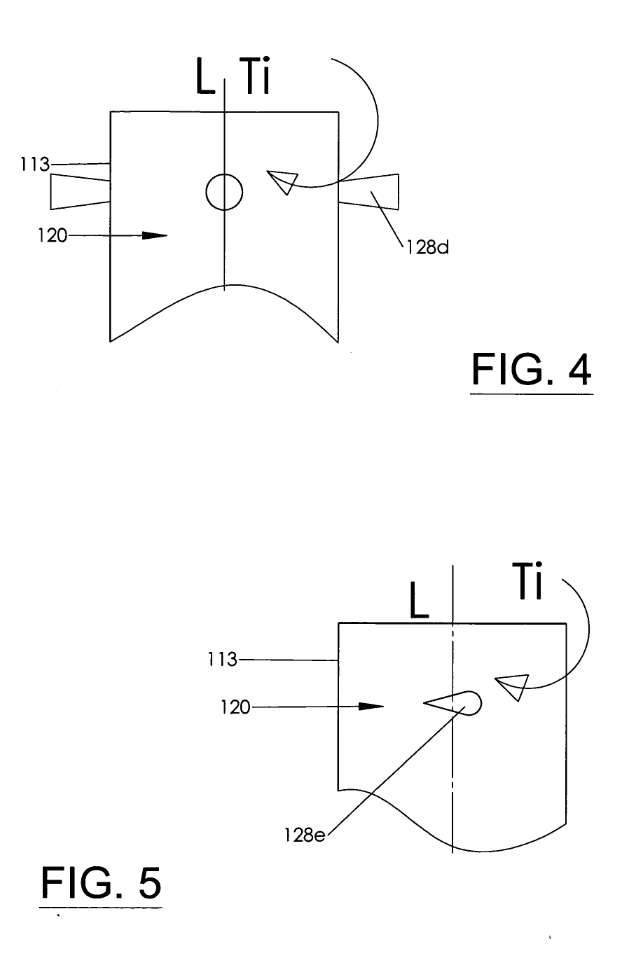

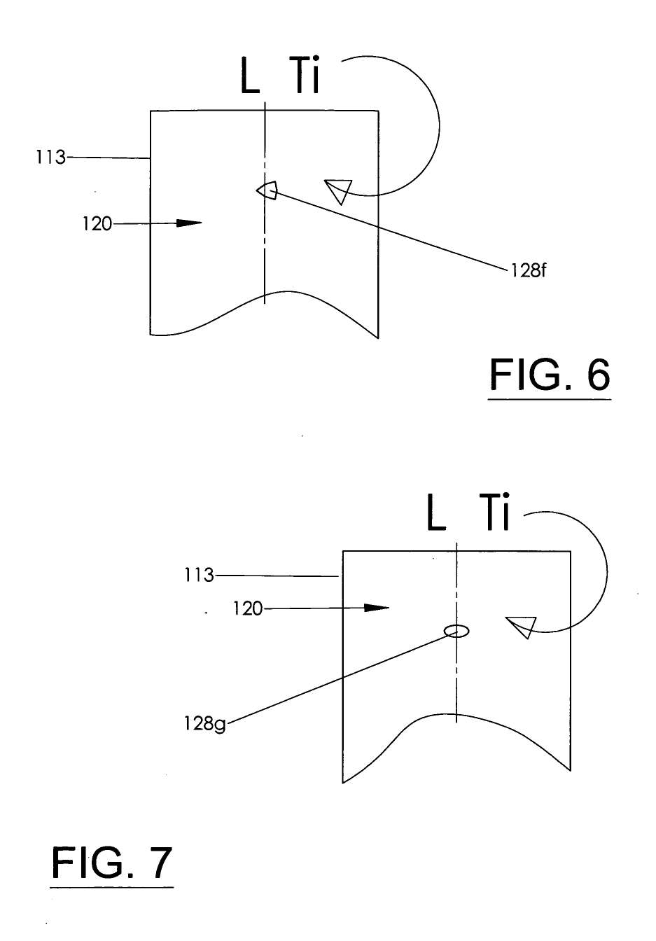

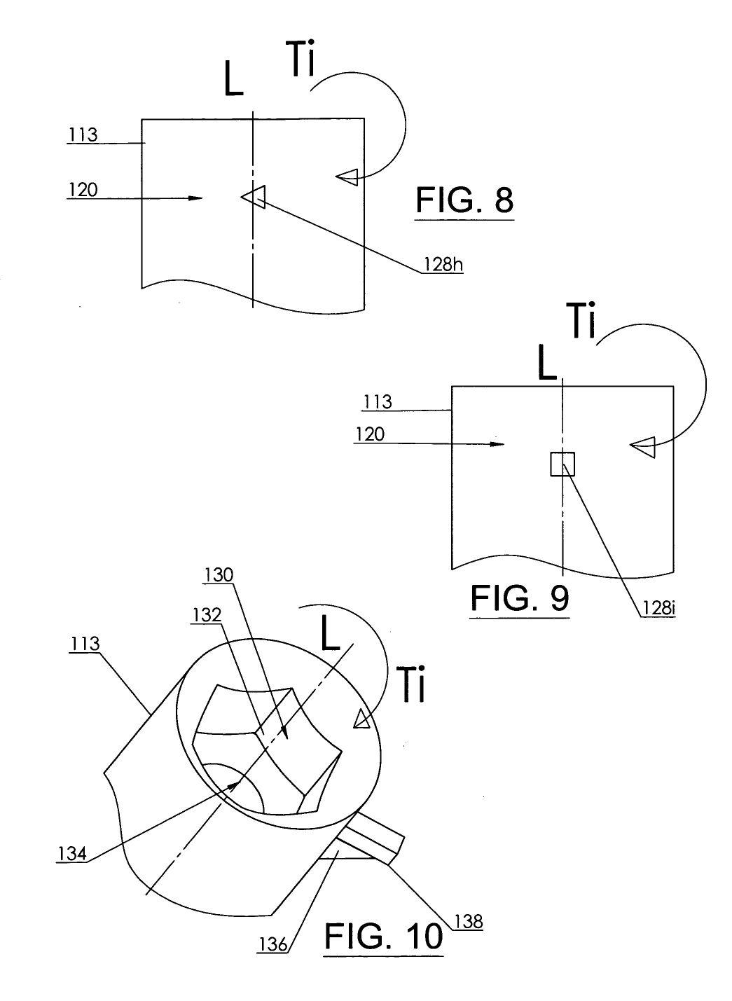

The at least one wing 122 may have any desirable wing section 128, as well as different planforms. For example, and for illustrative purposes only, FIGS. 2 to 9 show exemplary wing sections and or planforms, wherein similar features are denoted by similar numbers subsequently denoted by subscript letter following each exemplary feature (where applicable). Thus, FIG. 2 schematically illustrates a rhomb wing section 128_{b}: FIG. 3 schematically illustrates a circular wing section 128_{c}; FIG. 4 schematically illustrates an inverted frusto-conical wing side view 128_{d}; FIG. 5 schematically illustrates a teardrop wing section 128ₑ; FIG. 6 schematically illustrates a trigon wing section 128_{f}, FIG. 7 schematically illustrates an ellipsoid wing section 128_{g}; FIG. 8 schematically illustrates a triangular wing section 128ₕ; and, FIG. 9 schematically illustrates a square wing section 128ᵢ.

As may be indicated in FIGS. 1a, 1b, 10, 11a, 11b, 12, 13, and 14, the wing implant body 112 may have an impression 130 at its distal end 120, possibly a hex-shaped socket 132. Additionally, the wing implant body may be formed with a threaded receptacle to 134 to receive a threaded screw or bolt (not shown). FIG. 10 further illustrates that the at least one wing 122 may further have a wing support 136 which may extend from an apical face 138 of the at least one wing 122 to terminate at the distal end 120 of the implant body 112.

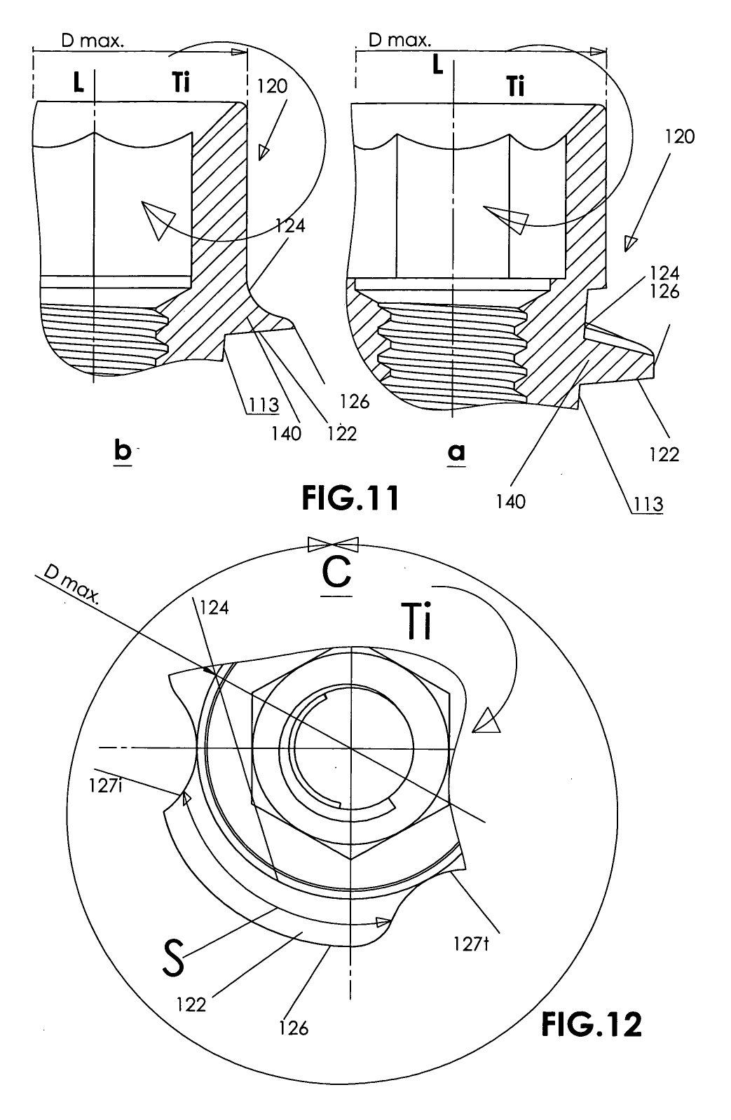

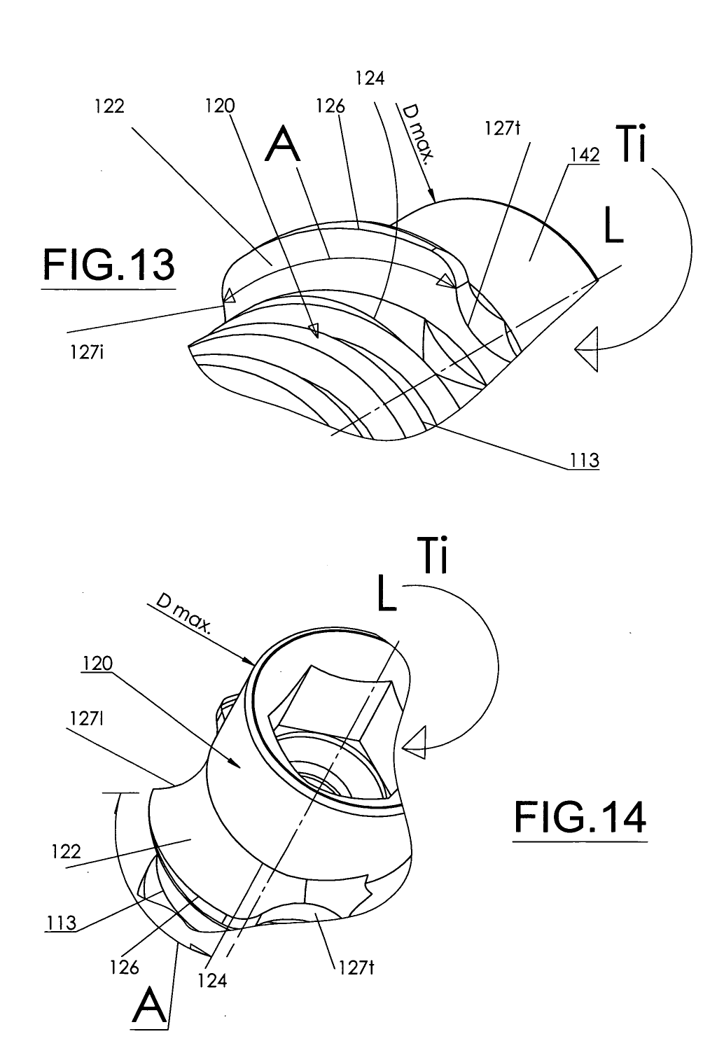

Similarly, other possible embodiments of the winged implant are further schematically illustrated in FIGS. 11 to 15. For example, FIG. 11 shows a longitudinal cross-wing section through a distal end 120 of the winged implant 110, showing a wing cross-wing section 140 of the at least one wing 122. The wing cross-wing section 140 is trapezoid in shape having a wide wing root 124 and tapering away towards the wing tip 126. Potentially, the at least one wing generally follows a spiral path along a periphery 142 of the distal end 120 of the wing implant 110 (as may best be seen in FIG. 13, and may potentially form a portion of a helical thread. Further possibly, FIG. 1b schematically illustrate a further narrowing of the wing tip 126 of the at least one wing, to facilitate threading-in of the winged implant 110.

The at least one wing 122 may extend generally transversely to the longitudinal axis L, projecting generally radially away from the distal end 120, from a wing root 124 where the at least one wing 120 essentially merges with the implant body 112, to a wing end 126, and may extend peripherally from a leading end 127i to a trailing end 127t. The leading end 127i is disposed tangentially forwardly along a threading-in direction Ti relative to the trailing end 127t. The at least one wing may generally project beyond the maximal diameter D_{Max} of the anchor body 112 at the distal end 120 thereof a span S extending between the wing root 124 to the wing end 126. A chord arch A, or a peripheral extent of the at least one wing 122, may extent peripherally along a circumference C of the distal end 12 of the implant body 112 such that the extent of the chord arch A may be considerably smaller than the extent of the circumference C.

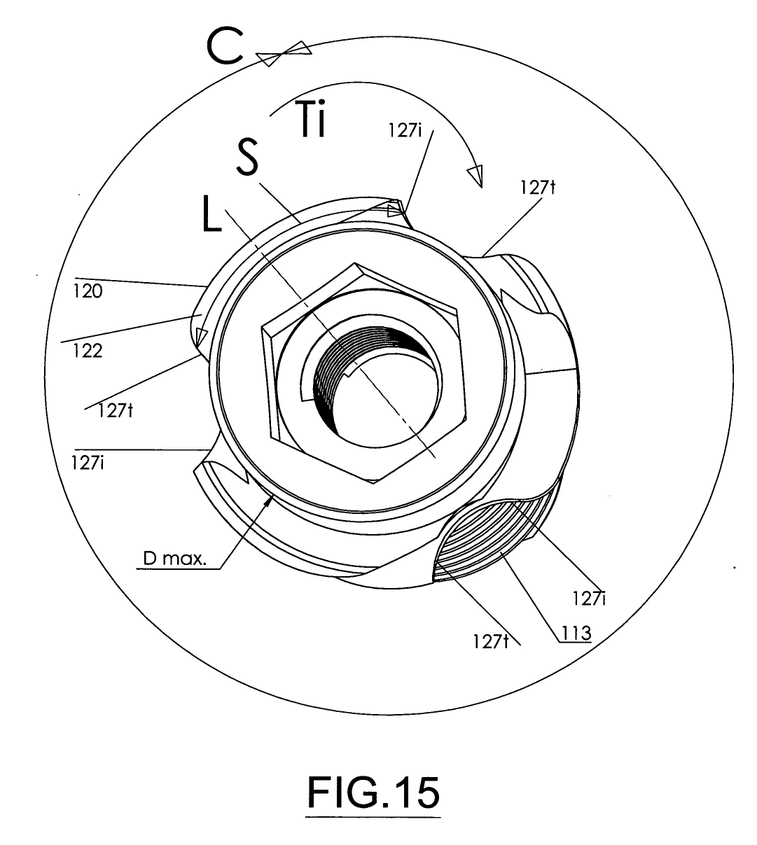

Further, FIGS. 12, 13 and 14 exemplarily illustrate a top, bottom perspective, and top perspective views, respectively, of the at least one wing 122. FIG. 15 illustrate a top view of yet another exemplary embodiment of the wing implant 110 comprising three instances of the at least one wing 122. Each of the at least one wing 122 instances may be located at a different height H, and/or staggered either circumferentially and/or longitudinally about the distal end 120 of the anchor body 112. Possibly, all three instances of the at least one wing may be disposed along a single helix (not shown).

During an implant procedure, an exemplary method of enhancing stability of the implant may be employed. According to such exemplary method, the implant body may be provided with at least one wing, extending generally away from the wing implant body adjacent a distal end thereof When the winged implant is implanted, for example in a crater which may be formed during implant procedure, the implant body may be further supported by the at least one wing, thereby enhanced stability of the winged implant in the crater may be effected.

All directional references (such as, but not limited to, upper, lower, upward, downward, left, right, leftward, rightward, top, bottom, above, below, vertical, horizontal, clockwise, and counter-clockwise, tangential, axial and/or radial, or any other directional and/or similar references) are only used for identification purposes to aid the reader's understanding of the embodiments of the present disclosure, and may not create any limitations, particularly as to the position, orientation, or use unless specifically set forth in the claims. Similarly, joinder terminology (such as, but not limited to, attached, coupled, connect, accommodate and the like and their derivatives) are to be construed broadly and may include intermediate members between a connection of elements and relative movement between elements. As such, joinder references may not necessarily infer that two elements are directly connected and in fixed relation to each other.

In some instances, components are described with reference to “ends” having a particular characteristic and/or being connected with another part. However, those skilled in the art will recognize that the present disclosure is not limited to components which terminate immediately beyond their points of connection with other parts. Thus, the term “end” should be interpreted broadly, in a manner that includes areas adjacent, rearward, forward of, or otherwise near the terminus of a particular element, link, component, part, member or the like. Additionally, all numerical terms, such as, but not limited to, “first”, “second”, “third”, or any other ordinary and/or numerical terms, should also be taken only as identifiers, to assist the reader's understanding of the various embodiments, variations and/or modifications of the present disclosure, and may not create any limitations, particularly as to the order, or preference, of any embodiment, variation and/or modification relative to, or over, another embodiment, variation and/or modification.

In methodologies directly or indirectly set forth herein, various steps and operations are described in one possible order of operation, but those skilled in the art will recognize that steps and operations may be rearranged, replaced, or eliminated without necessarily departing from the spirit and scope of the present disclosure as set forth in the claims. It is intended that all matter contained in the above description or shown in the accompanying drawings shall be interpreted as illustrative only and not limiting. Changes in detail or structure may be made without departing from the spirit of the present disclosure as defined in the appended claims.

While an exemplary embodiment has been described and shown in the accompanying drawings, it is to be understood that such an embodiment is merely illustrative of and not restrictive on the broad present disclosure, and that this disclosure may not be limited to the specific constructions and arrangements shown and described, since various other modifications and/or adaptations may occur to those of ordinary skill in the art. It is to be understood that individual features shown or described for the exemplary embodiment in the context of functional elements and such features may be replicated, or be omitted within the scope of the present disclosure and without departing from the spirit of the present disclosure as may be defined in the appended claims.

1. A method for enhancing stability of implants, the method comprising steps of:
providing an implant having a longitudinal axis L and comprising and implant body; and
providing the implant body with at least one wing, so that during an implant procedure the implant is implanted in a crater formed in an osseous tissue, whereby the at least one wing of the implant body may offer further support of the implant in the crater, thereby enhancing stability of the implant.

2. The method of claim 1, wherein the at least one wing extends transversely to longitudinal axis L away from a wing root adjacent the implant body to a wing tip, the wing tip at least abuts a sidewall of the crater.

3. The method of claim 2, wherein the wing tip penetrates the sidewall of the crater.

4. An implant having a longitudinal axis L and comprising an implant body provided with at least one wing adjacent a distal end of the implant body, the at least one wing extending generally transversely to the longitudinal axis L from a wing root where the at least one wing joins the implant body to a cantilevered wing end, and extending peripherally from a leading end to a trailing end of the at least one wing, comprising a chord arch extending from a tangentially forwardly disposed leading end to a tangentially rearwardly disposed trailing end, the chord arch having a peripheral extent that is considerably smaller than an extent of a circumference of the distal end of the implant body.

5. The implant of claim 4, wherein the at least one wing having an arbitrary wing section.

6. The implant of claim 5, wherein the at least one wing comprising a wing support extending from an apical face of the at least one wing to terminate at the distal end of the implant body.

7. The implant of claim 4, wherein the wing implant body may have an impression at its distal end.

8. The implant of claim 7, wherein the wing implant body is formed with a threaded receptacle to receive a threaded screw or bolt.

9. The implant of claim 4, wherein a longitudinal cross-wing section through a distal end of the winged implant comprises a wing chord section of a trapezoid in shape having a wide wing root and tapering away towards a wing tip.

10. The implant of claim 4, wherein the at least one wing generally follows a spiral path along a periphery of the distal end of the wing implant.

11. The implant of claim 10, wherein the at least one wing forms a portion of a helical thread.

12. The implant of claim 4, wherein the at least one wing comprises a narrowing of the wing tip, to facilitate threading-in of the implant.

13. The implant of claim 4, wherein a chord arch A, or a peripheral extent of the at least one wing, extends peripherally along a circumference C of the distal end of the implant body such that the extent of the chord arch A may be considerably smaller than the extent of the circumference C.

14. The implant of claim 4, wherein the implant comprises a plurality of instances of the at least one wing.

15. The implant of claim 14, wherein each of the at least one wing instances is located at a different height H as measured longitudinally away from the distal end.

16. The implant of claim 15, wherein each instance of the at least one wing is staggered circumferentially about the distal end of the anchor body.

17. The implant of claim 16, wherein each instance of the at least one wing is staggered longitudinally relative to the distal end of the anchor body.

18. The implant of claim 16, wherein all instances of the at least one wing are disposed about a single helix.
